(19) United States
(12) Patent Application Publication
(10) Pub. No.: US 2006/0210859 A1
(43) Pub. Date: Sep. 21, 2006

(54) Pump having noise-proof and vibration-proof structure and fuel cell system using the same

(76) Inventors: Sang Hyeon Choi, Yongin-si (KR); Jong Ki Lee, Yongin-si (KR); Won Hyouk Jang, Yongin-si (KR); Jun Won Suh, Yongin-si (KR); Dong Yun Lee, Yongin-si (KR); Ri A. Ju, Yongin-si (KR); Eun Suk Cho, Yongin-si (KR); Jin Hong An, Yongin-si (KR)

Correspondence Address: Robert E. Bushnell, Suite 300, 1522 K Street, N.W., Washington, DC, 20005, US

(21) Appl. No.: 11/368,599

(22) Filed: Mar. 7, 2006

(30) Foreign Application Priority Data
Mar. 7, 2005 (KR) 2005-18838

(51) Int. Cl. H01M 8/04; F04B 17/00; F04B 39/00

(52) U.S. Cl. 429/34; 417/355; 417/572

(57) ABSTRACT

A pump for a fuel cell of a noise suppression and vibration proof structure and a fuel cell system using the same. The pump includes a housing including a metal housing main body and an inlet hole and an outlet hole for receiving and discharging a fluid and a pump inserted into the housing and including an inlet pipe through which the fluid is received and an outlet pipe that passes through the outlet hole and through which the received fluid is discharged with predetermined pressure. Therefore, the noise and vibration of the pump are reduced.

### CROSS-REFERENCE TO RELATED APPLICATIONS AND CLAIM OF PRIORITY

This application claims the benefit of Korean Patent Application Nos. 2005-18838, filed on Mar. 7, 2005 and Pat. No. 2005-18840, filed on Mar. 7, 2005, with the Korean Intellectual Property Office, the disclosures of which are incorporated herein by reference. This application is related to application serial number (to be determined) filed on the same date as this application, entitled “PUMP HAVING NOISE-PROOF AND VIBRATION-PROOF STRUCTURE AND FUEL CELL SYSTEM USING THE SAME”, the disclosure of which is incorporated herein by reference.

### BACKGROUND

1. Field of the Invention

The present invention relates to a pump for a fuel cell and a fuel cell system using the same, and more particularly to, a pump for a fuel cell having a noise suppression and vibration proof structure capable of significantly reducing the noise and vibration of a fuel cell system using a metal housing structure, and a fuel cell system using the same.

2. Discussion of Related Art

A fuel cell is a power generation system for directly converting chemically reactive energy of hydrogen and oxygen contained in hydrocarbon series material such as methanol, ethanol, and natural gas into electric energy.

The fuel cell is divided into a phosphoric acid fuel cell, a molten carbonate fuel cell, a solid oxide fuel cell, a polymer electrolyte membrane fuel cell, and an alkaline fuel cell in accordance with the kind of used electrolyte. Each fuel cell operates by the same principle, however, varies with the kind of used fuel, operation temperature, catalyst, and electrolyte.

Among the above fuel cells, the polymer electrolyte membrane fuel cell (PEMFC) has an output characteristic remarkably higher than the output characteristics of the other fuel cells, operates at low temperature, has fast starting and response characteristics, and is widely used for a dispersive power source such as a static power station of a house and a public building as well as a portable power source such as a portable electronic apparatus and a transportable power source such as a vehicle power source.

The above-described PEMFC includes a stack, a reformer, a fuel tank, and a fuel pump. The PEMFC supplies the fuel in the fuel tank to the reformer by the operation of the fuel pump. The reformer reforms the fuel to generate hydrogen gas. In the stack, the hydrogen gas and the oxygen electrochemically react to generate electric energy.

Also, the fuel cells include a direct methanol fuel cell (DMFC) that is similar to the PEMFC and that can directly supply liquid methanol fuel to the stack. Since the DMFC does not use the reformer unlike the PEMFC, it is advantageous to making the size of the DMFC small.

The fuel cell stack commonly has a structure in which several or several tens of unit fuel cells each comprised of a membrane electrode assembly (MEA) and a separator are stacked. Here, the MEA has a structure in which an anode (also referred to as a negative electrode) and a cathode (also referred to as a positive electrode) are attached to each other with a polymer electrolyte membrane interposed. The fuel cell stack is compressed and sealed up in order to remove non-uniform operation conditions such as the pressure drop in the stack or the decrease of the oxygen concentration. FIG. 1 schematically illustrates the operation principle of a common fuel cell including the polymer electrolyte membrane. Referring to FIG. 1, a MEA 20 of a fuel cell 10 includes a polymer electrolyte membrane 12, an anode catalyst layer 14, and a cathode catalyst layer 16. When the fuel containing the hydrogen gas or hydrogen is supplied to the anode catalyst layer 14 in the fuel cell 10, electrochemical oxidation occurs in the anode catalyst layer 14 so that ionization and oxidation are perform to generate hydrogen ions H₊ and electrons e⁻. The ionized hydrogen ions are transmitted from the anode catalyst layer 14 to the cathode catalyst layer 16 through the polymer electrolyte membrane 12. The electrons are transmitted from the anode catalyst layer 14 to the cathode catalyst layer 16 through an external wiring line 18. The hydrogen ions transmitted to the cathode catalyst layer 16 perform electrochemical reduction of the oxygen supplied to the cathode catalyst layer 16 to generate heat and water. Electrical energy is generated by the transmission of the electrons.

The electrochemical reactions of the PEMFC and the DMFC will be represented as follows in EQUATIONS 1 and 2, respectively.
ANODE: H₂→2H⁺+2e⁻
CATHODE: ½O₂+2H⁺+2e⁻→H₂O [EQUATION 1]
ANODE: CH₃OH+H₂O →CO₂+6H++6e⁻
CATHODE: 3/2O₂+6H⁺+6e⁻→3H₂O [EQUATION 2]

The fuel cell system may be divided into an active fuel cell system that supplies fuel and air containing hydrogen to a fuel cell stack through the operation of a fuel pump and an air pump and a passive fuel cell system that supplies fuel or air without using a pump.

The output of the active fuel cell system is higher than the output of the passive fuel cell system. However, since the fuel cell stack is compressed and sealed up with a plurality of fuel cells stacked, the fuel cell stack of such a structure has predetermined internal pressure. Therefore, in order to supply an enough amount of air to the fuel cell stack with the predetermined internal pressure considering oxygen depletion, a high output air pump must be used. As described above, the high output air pump must be used for the conventional active fuel cell system so that large noise and vibration are generated.

Also, the conventional active fuel cell system commonly includes at least one fuel pump other than the air pump. In this case, the fuel pump in the conventional active fuel cell system additionally generates noise and vibration. The noise and vibration of the pumps causes user to be discomfort during the continuous operation of the fuel cell.

Furthermore, when the active fuel cell system is used as a power source supply device of each of electronic apparatuses such as a notebook computer, a portable multimedia player (PMP), a portable digital video disc (DVD) player, a personal digital assistant (PDA), a mobile telephone, and a camcorder, the noise and vibration of the fuel cell system make users uncomfortable. Therefore, in order to make the users comfortable and to facilitate the use of the electronic apparatuses, the generation of the noise of the fuel cell must be prevented.

### SUMMARY OF THE INVENTION

Accordingly, it is an object of the present invention to provide a pump with a noise suppression and vibration proof structure.

It is also an object of the present invention to provide a pump for a fuel cell of a noise suppression and vibration proof structure in which the housing of a pump mounted in a fuel cell system has a new metal housing structure so that noise suppression and vibration proof effects are significantly improved.

It is another object of the present invention to provide an active fuel cell system using the above-described pump for the fuel cell of the noise suppression and vibration proof structure.

In order to achieve the foregoing and/or other objects of the present invention, according to a first aspect of the present invention, there is provided a pump apparatus with a housing comprised of a metal housing main body that absorbs and intercepts the noise generated therein and an inlet hole and an outlet hole for receiving and discharging a fluid and a pump inserted into the housing and including an inlet pipe through which the fluid is received and an outlet pipe that passes through the outlet hole and through which the received fluid is discharged with predetermined pressure.

The metal housing main body preferably comprises a porous first metal housing main body for converting sound energy into heat energy to absorb noise and a second metal housing main body that surrounds the first metal housing main body to prevent the sound energy from being transmitted to the outside. The first metal housing main body is formed of aluminum foam. Also, the first metal housing main body is separated from the second metal housing main body by a predetermined distance by the barrier rib formed on the second metal housing main body. The second metal housing main body is formed of metal of higher density than the first metal housing main body.

Also, the metal housing main body comprises a first metal housing main body and a second metal housing main body that accommodates the first metal housing main body and the space between the first and second metal housing main bodies is formed to be vacuous.

Also, the housing comprises a cover with which the metal housing main body is covered and the cover comprises the inlet hole and the outlet hole. The cover is formed of synthetic polymer material such as synthetic resin, synthetic fiber, and synthetic rubber or metal having higher density than the synthetic polymer material to obtain excellent noise absorbing effect.

Also, the housing comprises a first cover including the inlet hole to cover one end of a through-opening of the metal housing main body and a second cover including the outlet hole to cover the other end of the through-opening of the metal housing main body.

Also, the pump for the fuel cell of the noise suppression structure further comprises a noise absorbing member inserted into the housing to surround the pump.

According to a second aspect of the present invention, there is provided a pump for a fuel cell of a noise suppression and vibration proof structure comprising a pump including an inlet pipe for receiving a fluid and an outlet pipe for discharging the fluid and supplying one of fuel containing hydrogen and oxidant to a fuel cell stack and a housing provided on the external surface of the pump by molding and including an inlet hole and an outlet hole for receiving and discharging the fluid.

The housing is preferably formed of one selected from the group consisting of metal, rubber, and polyurethane silicon.

According to a third aspect of the present invention, there is provided a fuel cell system comprising at least one electricity generator including electrolyte membrane and an anode and a cathode attached to the both surfaces of the electrolyte membrane to generate electric energy by the electrochemical reaction between fuel containing hydrogen and oxidant supplied to the anode and the cathode and a fuel supplying unit including the pump in accordance with the first aspect of the present invention that supplies the oxidant to the electricity generator.

The fuel cell system preferably further comprises a controller for controlling the operation of the pump.

### BRIEF DESCRIPTION OF THE DRAWINGS

A more complete appreciation of the present invention, and many of the above and other features and advantages of the present invention, will be readily apparent as the same becomes better understood by reference to the following detailed description when considered in conjunction with the accompanying drawings in which like reference symbols indicate the same or similar components, wherein:

FIG. 1 illustrates an operation principle of a common fuel cell including polymer electrolyte membrane;

FIG. 2 is a block diagram illustrating a fuel cell system for which a pump for a fuel cell of a noise suppression and vibration proof structure according to a preferred embodiment of the present invention is used;

FIG. 3 is a perspective view illustrating a pump apparatus according to a first embodiment of the present invention;

FIG. 4 is a perspective view illustrating a metal housing main body used in the air pump apparatus of FIG. 3;

FIG. 5 is a sectional view of the pump apparatus of FIG. 3;

FIG. 6 is a perspective view illustrating a pump apparatus according to a second embodiment of the present invention;

FIG. 7 is a sectional view illustrating a pump apparatus according to a second embodiment of the present invention; and

FIG. 8 is a perspective view illustrating a pump apparatus according to a third embodiment of the present invention.

### DETAILED DESCRIPTION OF PREFERRED EMBODIMENTS

Hereinafter, preferred embodiments of the present invention will be described with reference to the attached drawings. In the drawings, the thickness and size of elements are exaggerated for clarity. The same reference numerals in different drawings represent the same element.

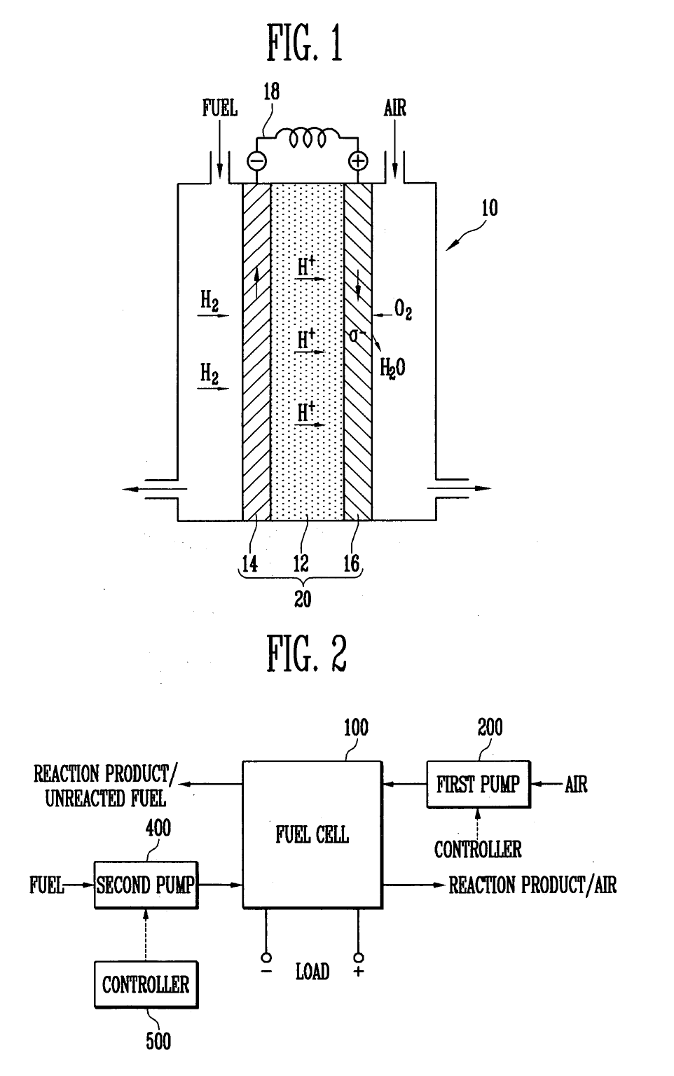

FIG. 2 is a block diagram illustrating a fuel cell system for which a pump for a fuel cell with a noise suppression and vibration proof structure according to a preferred embodiment of the present invention is used.

Referring to FIG. 2, the fuel cell system significantly reduces vibration and noise generated by pumps using a new pump housing structure to be suitably used as a portable fuel cell, in particular, to be suitably used as a power source supply device of an electronic apparatus such as a notebook computer and a camcorder.

The fuel cell system according to the present embodiment includes a fuel cell 100, a first pump apparatus 200, a second pump apparatus 400, and a controller 500.

To be specific, the fuel cell 100 includes at least one unit fuel cell (not shown) that generates electric energy. Here, the unit fuel cell is an electricity generator that generates predetermined voltage and current by an electrochemical reaction. The fuel cell 100 may include a stack structure in which a plurality of unit fuel cells are stacked. In this case, the fuel cell stack is commonly compressed and sealed up in order to smoothly supply oxygen by the air pump.

The electricity generator is composed of a membrane-electrode assembly (MEA) that generates electric energy by oxidation and reduction between hydrogen and oxygen and a separator attached to the both surfaces of the MEA to transmit fuel containing hydrogen and oxidant, for example, oxygen or air to the MEA. The MEA includes polymer electrolyte membrane and an anode and a cathode attached to the both surfaces thereof. The separator may be omitted in accordance with the structure of the fuel cell 100. According to the above-described structure, the fuel cell 100 generates electric energy and discharges water and carbon dioxide obtained as reaction products. The fuel and air that do not react in the fuel cell 100 are discharged to the outside of the fuel cell 100 together with carbon dioxide and water. The fuel that does not react may be supplied to the fuel cell 100 again through a circulation path for recycling.

Also, the fuel cell 100 applies a predetermined voltage, for example, 12V to external load through the plurality of unit fuel cells serially connected to each other and/or connected to each other in parallel. At this time, the voltage applied from the fuel cell 100 to the external load is converted into a predetermined level by a power converting unit such as a DC-DC converter and then, may be applied as the predetermined voltage. Here, the external load includes electronic apparatuses such as a notebook computer, a portable multimedia player (PMP), a portable digital video disc (DVD) player, a personal digital assistant (PDA), and a camcorder.

The first pump apparatus 200 is coupled to the cathode side of the fuel cell 100 to supply oxygen or air to the cathode in the fuel cell 100. The first pump apparatus 200 includes an air pump or a blower.

Also, the first pump apparatus 200 supplies enough air containing oxygen of no less than a required amount to the fuel cell 100 of the compressed and sealed structure in order to let the fuel cell 100 continuously operate. In the conventional active fuel cell system, large noise is generated by the air pump. However, in the fuel cell system according to the present embodiment, the structure of preventing the noise and vibration of the air pump is used so that it is possible to significantly reduce the noise and vibration compared with the conventional fuel cell system. Here, the noise that makes the user of the fuel cell uncomfortable is generated by the rotation of the motor or pressure in the air pump. The vibration is vertical or horizontal reciprocating motion generated by the pumps due to the rotation of the motor and the pressure in the air pump. The vibration causes the noise.

The second pump apparatus 400 is coupled to the anode side of the fuel cell 100 to supply hydrogen or the fuel containing hydrogen (e.g., a hydrogen compound such as methanol or a mixed fuel in which a hydrogen compound such as methanol and water are mixed) stored in a fuel tank (not shown), to the anode in the fuel cell 100. Here, the second pump apparatus 400 is a fuel pump. In the fuel cell system according to the present embodiment, in order to prevent the noise and vibration of the fuel pump, the fuel pump may be inserted into the metal housing. At this time, the metal housing may be obtained by molding metal. In this case, it is possible to significantly reduce the noise and vibration of the pumps compared with the conventional fuel cell system.

The controller 500 controls the operations of the first and second pump apparatuses 200 and 400. The controller 500 applies control signals for turning on and off the operations of the first and second pump apparatuses 200 and 400 to the first and second pump apparatuses 200 and 400 in response to the start signal that requests the operation of the fuel cell 100. The controller 500 also controls at least one of various power source supply devices such as a battery, a capacitor, a utility power source, and a fuel cell to be electrically connected to the first and second pump apparatuses 200 and 400 in order to supply required power to the first and second pump apparatuses 200 and 400. In this case, the controller 500 may connect at least one power source among the battery, the capacitor, and the utility power source to the first and second pump apparatuses 200 and 400 when the fuel cell 100 is initially driven and connect the fuel cell 100 as a power source to the first and second pump apparatuses 200 and 400 after the fuel cell 100 is normally driven.

A noise suppression and vibration proof structure is described in more detail as follows:

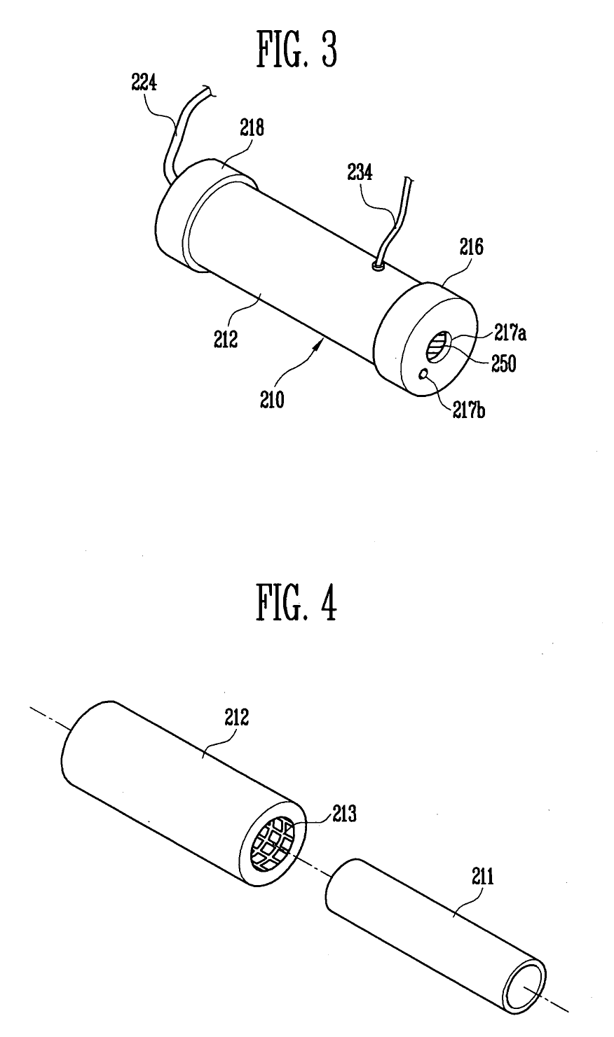

FIG. 3 is a perspective view illustrating an air pump according to a first embodiment of the present invention.

Referring to FIG. 3, the air pump apparatus 200 having the noise suppression and vibration proof structure according to the present embodiment includes a housing 210 composed of a metal housing main body 212 which has preferably a cylindrical shape and first and second covers 216 and 218 inserted into both ends of the housing main body 212 to cover the through-opening of the main body 212. The external air is inputted to the pump apparatus 200 through the two inlet holes 217a and 217b formed in the first cover 216 and a filter 250. The power source line 234 of the pump passes through the housing 210 from the inside of the pump apparatus 200 to be drawn to the outside.

When the air pump is inserted into the housing main body 212 formed of predetermined metal, it is possible to effectively absorb the noise of the air pump. This is because, since the metal has high density, the metal absorbs noise better than the other materials such as rubber and plastic.

Also, the metal housing main body 212 is preferably cylindrical so that the cylindrical air pump can be easily inserted into the housing main body 212. The metal housing main body 212 may be in the form suitable for accommodating the air pump in accordance with the shape of the air pump, for example, in the form of a box.

The first and second covers 216 and 218 are formed of material suitable for closely covering the opening of the metal housing main body 212. For example, a part of the covers 216 and 218 may be formed of metal so that the noise in the housing 210 can be properly absorbed.

FIG. 4 is a perspective view illustrating the metal housing main body used for the air pump according to a first embodiment of the present invention.

Referring to FIG. 4, the metal housing main body according to the present embodiment is formed of a double metal housing main body. That is, the metal housing main body is composed of a first metal housing main body 211 and a second metal housing main body 212 into which the first metal housing main body 211 is inserted.

To be specific, the first metal housing main body 211 is formed of metal madreporite, that is, metal foam and is in the form of a cylinder whose top and bottom surfaces are opened. In this case, the first metal housing main body 211 is an aggregate of independent foams so that the foams form an interconnected network through minute cracks formed in barrier membranes that define the respective foams. According to such a structure, there is a friction between the wave surface of the barrier membrane and the sound wave so that sound energy is converted into heat energy. As a result, excellent noise absorbing effect is obtained. The metal foam that can be used as the first metal housing main body 211 is, for example, aluminum foam having an excellent light property, incombustibility, high strength, an excellent noise absorbing property, and an excellent moisture proof property.

The second metal housing main body 212 is in the form of a cylinder in which the first metal housing main body 211 is accommodated and whose both surfaces are opened. Also, the second metal housing main body 212 is formed of a high density member, that is, a metal member having higher noise absorbing effect than rubber or plastic. The second metal housing main body is preferably formed of metal with higher density than the first metal housing main body. The metal that can be used as the second metal housing main body 212 is, for example, aluminum having an excellent light property, incombustibility, high strength, an excellent noise absorbing property, and an excellent moisture proof property.

Also, the second metal housing main body 212 may be separated from the first metal housing main body 211 by a predetermined distance in order to improve the noise absorbing effect of the first metal housing main body 211. Preferably, a barrier rib 213 having the height corresponding to the predetermined distance is formed on the internal surface of the second metal housing main body 212. The barrier rib 213 may be in the form of a protrusion, a stripe, or a mesh.

The barrier rib 213 may not be integrated with the second housing main body 212 but may be integrated with the external surface of the first housing main body 212. The barrier rib 213 of the minimum number and size is provided between the main bodies 211 and 212 so that the first and second housing main bodies 211 and 212 do not contact each other or are not transformed in the vacuum process and that the effect of preventing noise and vibration is not reduced.

On the other hand, the first and second metal housing main bodies 211 and 212 may have a vacuum housing structure so that a vacuum space is provided between the first and second metal housing main bodies 211 and 212. In this case, an exhausting hole (not shown) for forming the vacuum space is provided in the first and/or second metal housing main bodies 211 and 212. The exhausting hole is sealed up after an exhausting process of forming the vacuum space between the first and second metal housing main bodies 211 and 212.

FIG. 5 is a sectional view of the air pump according to the first embodiment of the present invention. FIG. 5 illustrates the section obtained by cutting off the air pump in a longitudinal direction. The present embodiment is suitable for the case in which the metal housing main body is formed of the double metal housing.

Referring to FIG. 5, the air pump apparatus 200 with the noise suppression and vibration proof structure according to the present embodiment absorbs and intercepts sound energy so that the operation noise of the pumps provided in the housing 210 and the noise caused by the air received and discharged through the pumps are not transmitted to the outside when oxygen or air is received and discharged. Therefore, the air pump apparatus 200 includes a housing 210, a pumping unit 220, a motor 230, a noise absorbing member 240, and a filter 250. Here, the pumping unit 220 and the motor 230 form the air pump. To be specific, the housing 210 includes cylinder-shaped double metal housing main bodies 211 and 212 and first and second covers 216 and 218 that cover the both openings of the double metal housing main bodies 211 and 212. The housing 210 in the form of a chamber absorbs and intercepts the sound energy in the inside 214 of the fuel cell system to minimize the noise of the pumps. The cylinder-shaped double metal housing main bodies 211 and 212 have a housing structure with excellent characteristics of absorbing and intercepting the sound energy. That is, the cylinder-shaped double metal housing main bodies 211 and 212 according to an embodiment of the present invention form the double structure housing 210 composed of a porous first metal housing main body and a second metal housing main body that surrounds the first metal housing main body.

The first metal housing main body 211 and the second metal housing main body 212 may be directly combined with each other or form a predetermined space, for example, an air layer therebetween. Also, predetermined noise absorbing material pieces may be filled in the space between the first metal housing main body 211 and the second metal housing main body 212.

The first cover 216 is formed of a rubber, plastic, or metal member of a proper thickness to absorb the noise in the pump apparatus 200 and closely covers one end of the through-opening of the main bodies 211 and 212 in which an inlet hole is provided. That is, the first cover 216 is in the form of a circular plate to correspond to the shape of the one end of the through-opening and includes two inlet holes 217a and 217b opened so that oxygen or air flows to the inlet pipes 222 and 223 of the pumping unit 220. The first cover 216 covers the one end of the through-opening in the form of a square bracket seen from the section and supports the one end of the through-opening.

The second cover 218 is preferably formed of the same material as the first cover 216 and closely covers the other end of the through-opening of the main bodies 211 and 212. That is, the second cover 218 is in the form of a circular plate to correspond to the shape of the other end of the through-opening and includes an outlet hole 219 through which the outlet pipe 224 of the pumping unit 220 passes. The second cover 218 covers the other end of the through-opening in the form of a square bracket seen from the section and supports the other side of the housing 210.

The pumping unit 220 in the form of a chamber that includes the inlet pipes 222 and 223 and the outlet pipe 224 is provided in the housing 210. The pumping unit 220 receives the external air through the inlet pipes 222 and 223 to discharge the received air through the outlet pipe 224. Therefore, the pumping unit 220 includes a propeller 226 that generates rotary power or pumping power. Here, the propeller 226 is an example of means for obtaining the rotary power or the pumping power. The propeller 226 is combined with the rotating shaft 232 of the motor 230 in the center thereof.

The motor 230 is driven by the electric energy supplied from the power source supply device outside the pump apparatus 200 such as the battery, the capacitor, the utility power source or the fuel cell. The motor 230 includes a power source line 234 connected to the electric motor and the power source supply device. Also, the motor 230 includes the rotating shaft 232 that transmits the rotary power of the motor 230 to the propeller 226. The power source line 234 is drawn to the outside through the holes formed in the first and second metal housing main bodies 211 and 212. The power source line 234 may be drawn to the outside through the first cover 216.

On the other hand, the pumping unit 220 and the motor 230 are an example of the air pump for compressing the air in the housing 210. The air pump including the noise proof structure according to an embodiment of the present invention can be easily realized by an application of a reciprocating mechanical apparatus, for example, an air pump using a piston reciprocating motion as well as by an application of a rotating mechanical apparatus using the above motor and propeller.

The noise absorbing member 240 surrounds the pumping unit 220 and the motor 230 in the housing 210. In order to effectively arrange the noise absorbing member 240 in the housing 210, the noise absorbing member 240 is divided into predetermined pieces 242, 244, 246, and 248. The first and second noise absorbing member pieces 242 and 244 are provided to surround the circular side surface of the pumping unit 220. The third noise absorbing member piece 246 includes a hole 247 corresponding to the outlet pipe 224 of the pumping unit 220 and is provided between the pumping unit 220 and the second cover 218. The fourth noise absorbing member piece 248 includes two holes 249a and 249b corresponding to the two inlet holes 217a and 217b of the first cover 216 and is provided between the motor 230 and the first cover 216.

The noise absorbing member 240 is formed of fiber material, elastic material, or elastic porous material having an excellent property of absorbing sound energy. The noise absorbing member 240 stably fixedly supports the pumps inserted into the housing 210 as well as absorbs the noise in the housing 210.

As described above, in the air pump structure according to an embodiment of the present invention, the noise absorbing member 240 that surrounds the pumps inserted into the housing 210 is additionally provided so that it is possible to reduce the noise and vibration caused by the air pump apparatus 200.

The filter 250 purifies the air when the air is inputted into the inside 214 of the housing 210. That is, the filter 250 removes undesired components or gases that affect the fuel cell such as minute dusts, salt, and carbon dioxide included in the air. Therefore, the filter 250 is provided between the fourth noise absorbing member 248 and the first cover 216 and is fixedly supported by the fourth noise absorbing member 248 and the first cover 216. The filter 250 may be in the form of a circular sheet and a plurality of sheets may overlap each other. Any conventional filter may be used as the filter 250 only if the filter has an air purifying function.

Processes of manufacturing the air pump of the above noise suppression and vibration proof structure and of providing the air pump in the fuel cell system will be simply described as follows.

First, as illustrated in FIG. 4, the cylindrical and porous first metal housing main body 211 having a first diameter is inserted into the cylindrical second metal housing main body 212 having a second diameter that is slightly larger than the first diameter. At this time, the first metal housing main body 211 is inserted into the opening of the second metal housing main body 212 to be fixed to the second metal housing main body 212 and is supported by the edge portion of the other end of the opening of the second metal housing main body 212. Here, the diameter of the other end of the opening of the second metal housing main body 212 is slightly smaller than the diameter of the one end of the opening of the second metal housing main body 212. In the process, the second metal housing main body 212 if the barrier rib is not present or the barrier rib 213 of the second metal housing main body 212 is coated with predetermined adhesive such as aluminum structure adhesive so that the first metal housing main body 211 and the second metal housing main body 212 can be fixedly combined with each other.

Next, the cylindrical chamber of the pumping unit 220 combined with the motor 230 is surrounded by the first and second noise absorbing members 242 and 244. At this time, the first and second noise absorbing members 242 and 244 are in the form of a ring having predetermined diameter and width to surround the chamber of the pumping unit 220.

Next, the motor 230 is inserted into the first metal housing main body 211 together with the pumping unit 220 surrounded by the first and second noise absorbing members 242 and 244. The power source line 234 combined with the motor 230 is drawn to the outside through the holes formed in the first and second metal housing main bodies 211 and 212 to pass through the first and second metal housing main bodies 211 and 212.

Next, the fourth noise absorbing member 248 is inserted to contact the motor 230 in the one end of the through-opening of the housing 210 that faces the inlet pipes 222 and 223 of the pumping unit 220. The third noise absorbing member 246 is inserted to contact the motor 230 in the other end of the through-opening of the housing 210 that faces the outlet pipe 224 of the pumping unit 220.

Next, the filter 250 for purifying the air is inserted to contact the fourth noise absorbing member 248 in the one end of the through-opening of the housing 210. The one side of the through-opening of each of the housing main bodies 211 and 212 is covered with the first cover 216 excluding the inlet holes 217a and 217b for receiving the air. The other side of the through-openings of the housing main bodies 211 and 212 are covered with the second cover 218 so that the outlet pipe 224 of the pumping unit 220 is exposed through the inlet hole 219. As a result, the air pump for the fuel cell having the noise suppression and vibration proof structure is simply manufactured.

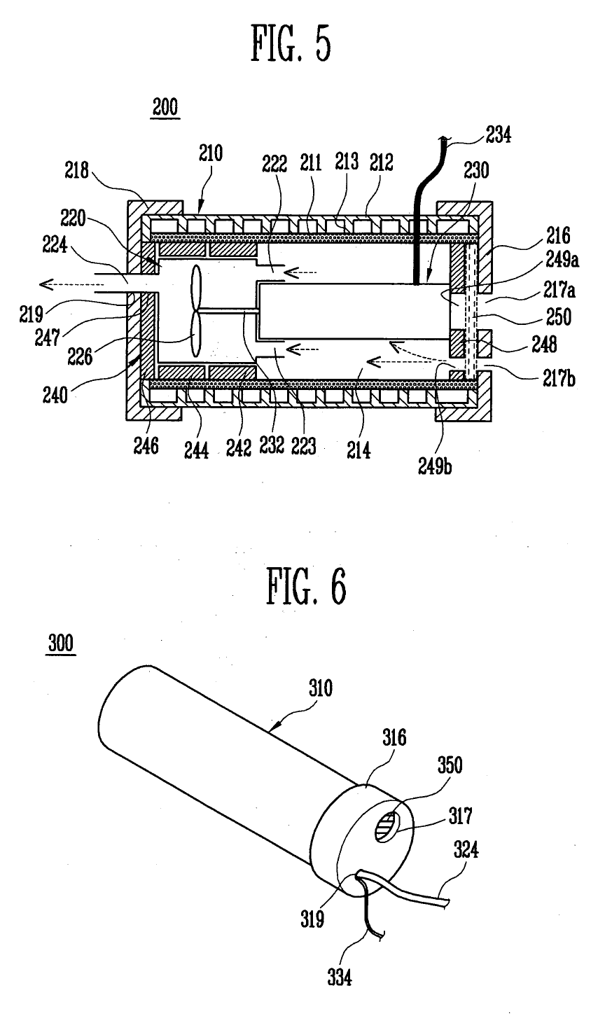

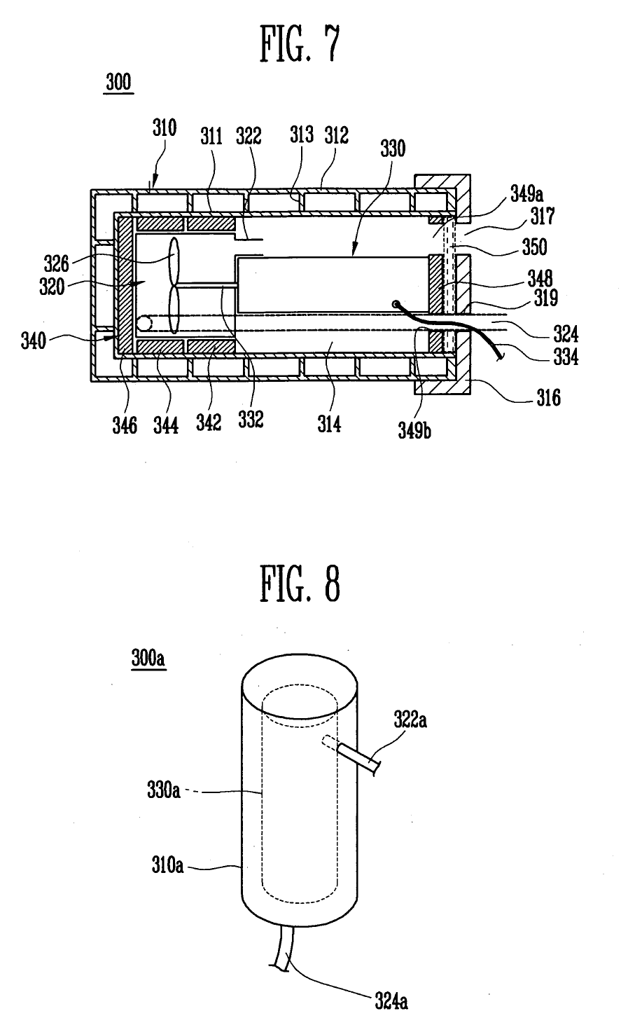

FIGS. 6 and 7 are a perspective view and a sectional view illustrating an air pump for a fuel cell having a noise suppression and vibration proof structure according to a second embodiment of the present invention. The present invention is suitable for the case in which the metal housing main body is formed of the double metal housing or a vacuum metal housing.

Referring to FIGS. 6 and 7, the air pump apparatus 300 for the fuel cell of the noise suppression and vibration proof structure according to an embodiment of the present invention includes a housing 310 composed of a cylindrical metal housing main body 312 that forms the external surface of the metal housing main body and a cover 316 inserted into the one end of the housing main body 312 to cover the one end of the housing main body. Here, the metal housing main body 312 is formed of the double metal housing or the vacuum metal housing.

The inlet hole 317 and the outlet hole 219 for receiving and discharging a fluid are provided in the cover 316. The discharge pipe 324 is drawn from the inside of the housing 310 to the outside of the housing 310 through the outlet hole 319 of the cover 316. The external air is inputted to the inside of the housing 310 through the inlet hole 317 formed in the cover 316 and the filter. Also, at least a part of the cover 316 is formed of metal in order to improve the noise absorbing effect.

The power source line 334 is drawn from the inside of the housing 310 to the outside through the outlet hole 317 of the cover 316.

To be specific, the housing 310 includes cylinder-shaped housing main bodies 311 and 312 and a cover 316 that covers one opening of the housing main bodies 311 and 312. The cylindrical housing main bodies 311 and 312 have a vacuum structure in which carrier such as the air is thin so that sound energy such as noise is not actually transmitted. That is, the cylindrical housing main bodies 311 and 312 according to the present embodiment are composed of the first housing main body 311 provided inside the housing 310 and the second housing main body 312 provided outside the first housing main body 311 with a vacuum space interposed between the first housing main body 311 and the second housing main body 312.

The first housing main body 311 is in the form of a cylinder having a predetermined diameter and includes an opening on one side. The first housing main body 311 is preferably formed of reinforced plastic and metal. Aluminum is used as the metal. Aluminum has an excellent light property, incombustibility, high strength, an excellent noise intercepting property, and an excellent water proof property. Therefore, aluminum is one of the materials that can be used as the housing main bodies of the present invention for preventing noise and vibration.

The second housing main body 312 is in the form of a cylinder having a diameter slightly larger than the diameter of the first housing main body 311. The second housing main body 312 is provided outside the first housing main body 311 so that the first housing main body 311 is inserted into the second housing main body 312 with the vacuum space interposed between the first housing main body 311 and the second housing main body 312. The second housing main body 312 is formed of the same material as the first housing main body 311.

Also, the second housing main body 312 includes a protrusion 313 of predetermined height so that the vacuum space is formed between the first housing main body 311 and the second housing main body 312. The protrusion 313 may be extended to a barrier rib in the form of a stripe or a mesh. Also, the protrusion 313 may not be integrated with the second housing main body 312 but may be integrated with the external surface of the first housing main body 312. The protrusion 313 of the minimum number and size is provided between the housing main bodies 311 and 312 so that the first and second housing main bodies 311 and 312 do not contact each other or are not transformed in the vacuum process and that the effect of preventing noise and vibration is not reduced.

Also, the second housing main body 312 is combined with the first housing main body 311 by predetermined adhering means after the first housing main body 311 is inserted into the second housing main body 312. Also, the second housing main body 310 includes an exhausting hole 315 for forming the vacuum space between the first and second housing main bodies 311 and 312. The exhausting hole 315 is sealed up by a predetermined sealing member 315a after an exhausting process for forming the vacuum space.

The cover 316 closely covers the opening of each of the housing main bodies 311 and 312. That is, the cover 316 in the form of a circular plate corresponding to the shape of the opening of each of the housing main bodies 311 and 312 covers the opening of each of the housing main bodies 311 and 312 in the form of a square bracket as illustrated in FIG. 7 and supports one side surface of the housing 310.

Also, the cover 316 is formed of synthetic resin or rubber of a proper thickness to absorb noise inside the housing 310. The cover 316 includes an inlet hole 317 through which a fluid, for example, the air is received and an outlet hole 319 through which the air compressed to predetermined pressure by the motor is discharged. Here, the air compressed by the pump is discharged to the outside of the pump 300 through the outlet pipe 324 that passes through the outlet hole 319.

The pumping unit 320 in the form of a chamber including the inlet pipe 322 and the outlet pipe 324 is provided in the housing 310. The pumping unit 320 receives the external air through the inlet pipe 322 and discharges the received air to the outlet pipe 324. Preferably, the pumping unit 320 includes a propeller 326 that generates rotary power or pumping power. Here, the propeller 326 is an example of means for obtaining the rotary power or the pumping power. The propeller 326 is combined with the rotating shaft 332 of the motor 330 in the center thereof.

The motor 330 is driven by the electric energy supplied from an additional power source supply device such as the battery, the capacitor, and the utility power source or the fuel cell. The motor 330 includes the rotating shaft 332 that transmits the rotary power generated by the motor 330 to the propeller 326. Also, the motor 330 includes a power source line 334 connected to the electric motor and the power source supply device. In FIG. 7, the power source line 334 is drawn from the motor 330 to the outside through the hole 349b of the noise absorbing member 348, the hole of the filter 350, and the outlet hole 319 of the cover 316.

The noise absorbing member 340 surrounds the pumping unit 320 and the motor 330 in the housing 310. In order to effectively arrange the noise absorbing member 340 in the housing 310, the noise absorbing member 340 is divided into predetermined pieces 342, 344, 346, and 348. The first and second noise absorbing member pieces 342 and 344 are provided to surround the circular side surface of the pumping unit 320. The third noise absorbing member piece 346 is provided on the side surface adjacent to the outlet pipe of the pumping unit 320. The fourth noise absorbing member piece 348 includes a hole 349a corresponding to the inlet hole 317 and a hole 349b through which the outlet pipe 324 of the pumping unit 320 passes and is provided between the motor 330 and the cover 316.

The filter 350 purifies the air when the air is inputted to the inside 314 of the housing 310. That is, the filter 350 removes undesired components or gases that affect the fuel cell such as minute dusts, salt, and carbon dioxide included in the air. Therefore, the filter 350 is provided between the fourth noise absorbing member 348 and the cover 316 in the opening of the housing 310 and is supported and fixed by the fourth noise absorbing member 348 and the cover 316. The filter 350 includes a hole through which the outlet pipe 324 of the pump 300 passes.

Processes of manufacturing the air pump of the above noise suppression and vibration proof structure and of providing the air pump in the fuel cell system will be simply described as follows.

First, the cylindrical first housing main body 311 having a first diameter is inserted into the cylindrical second housing main body 312 having a second diameter that is slightly larger than the first diameter so that the first housing main body 311 and the second housing main body 312 are combined with each other. Then, after the air between the first and second housing main bodies 311 and 312 is exhausted through the exhausting hole 315, the exhausting hole 315 is sealed up to seal up the housing 310.

Next, the third noise absorbing member 346 is provided on the bottom surface of the housing main body 311. At this time, the third noise absorbing member 346 may be replaced by small noise absorbing pieces.

Next, the cylindrical chamber of the pumping unit 320 is surrounded by the first and second noise absorbing members 342 and 344. The pumping unit 320 combined with the motor 330 is inserted into the housing main body 311 to contact the third noise absorbing member 346. When a space is generated between the pumping. unit 320 and the housing main body 311, additional noise absorbing pieces are additionally inserted so that the pumping unit 320 is attached to the internal surface of the housing main body 311.

Next, the fourth noise absorbing member 348 is inserted into the housing main body 311 to contact the motor 330 and the filter 350 is inserted into the housing main body 311 to contact the fourth noise absorbing member 348. The opening of the housing main bodies 311 and 312 is covered with the cover 316. At this time, the outlet pipe 324 of the pump inserted into the housing 310 and the power source line 334 are drawn to the outside through the hole 349b of the fourth noise absorbing member, the hole of the filter 350, and the outlet hole 319 of the cover 316. As a result, the air pump having the noise proof structure is simply manufactured.

Next, the air pump inserted into the housing having excellent noise suppression and vibration proof effect is fixed on the side surface of the fixed frame by a fixing member such as a belt to be separated from the lower frame of the fuel cell system by a predetermined distance. As a result, the fuel cell system having the noise suppression and vibration proof structure is completed.

As described above, the pump housing according to the present invention is composed of the metal housing main body and one cover with which the opening formed on one side thereof is covered.

On the other hand, according to the above-described embodiment, the opening of the metal housing main body is covered with the cover. However, the present invention is not limited to the above. After additionally forming a cover of a similar structure to the structure of the double metal housing or the vacuum housing, the cover may be combined with the opening of the metal housing main body by predetermined adhering means.

Also, according to the above-described embodiment, the air pump is taken as an example. However, the present invention is not limited to the above. The air pump may be easily realized by another pump or a fuel pump that supplies a fluid. That is, the fuel pump may be inserted into the metal housing main body to be applied to the fuel cell system. In this case, in the pump structure according to the above-described embodiment, the inlet pipe of the pumping unit is preferably drawn to the outside of the housing through the inlet hole of the cover.

Also, according to the above-described embodiment, the housing is cylinder-shaped. However, the present invention is not limited to the above and the housing may be in the form of a box or in the form obtained by combining the box shape and the cylinder shape with each other.

Also, according to the above-described embodiment, the housing main body and the cover are separated from each other. However, when the housing main body is formed by molding, the housing main body and the cover may be integrated with each other. For example, as shown in FIG. 8, a pump apparatus 300a may comprise a pump 330a having a inlet pipe 322a and a outlet pipe 324a, and a housing 310a formed by molding to surround the pump 330a. The housing 310a may be formed of metal, rubber, or polyurethane silicon.

Also, the fuel cell system according to the above embodiment is preferably formed of the PEMFC or the DMFC.

Although a few embodiments of the present invention have been shown and described, it would be appreciated by those skilled in the art that changes might be made in this embodiment without departing from the principles and spirit of the invention, the scope of which is defined in the claims and their equivalents.

As described above, in the pump structure including the housing, it is possible to effectively absorb and absorb the noise and vibration caused by the pumps. Also, it is possible to provide a fuel cell system in which noise and vibration are significantly reduced compared with the conventional fuel cell by using the above-described pump noise suppression structure. Also, it is possible to significantly improve the noise suppression and vibration proof characteristic of an application such as a notebook computer in which the fuel cell system is mounted.

What is claimed is:

1. A pump apparatus, comprising:
a housing comprising a metal housing main body having an inlet hole and an outlet hole for receiving and discharging a fluid, respectively; and
a pump inserted into the housing, the pump including an inlet pipe through which the fluid is received and an outlet pipe through which the received fluid is discharged with predetermined pressure, the outlet pipe passing through the outlet hole.

2. The pump apparatus as claimed in claim 1, wherein the metal housing main body comprises a porous first metal housing main body for absorbing noise and a second metal housing main body surrounding the first metal housing main body to absorb the noise.

3. The pump apparatus of claim 1, wherein the metal housing body comprises a first metal housing body and a second metal housing body accommodating the first metal housing body, and the first metal housing body comprises a metal foam capable of converting sound energy into heat energy to absorb noise and the second metal housing main body prevents sound energy from being transmitted to the outside of the pump.

4. The pump apparatus as claimed in claim 2, wherein the first metal housing main body is formed of aluminum foam.

5. The pump apparatus as claimed in claim 2, wherein the first metal housing main body is separated from the second metal housing main body with a predetermined distance by a barrier rib formed on the second metal housing main body.

6. The pump apparatus as claimed in claim 2, wherein the second metal housing main body is formed of metal with higher density than the first metal housing main body.

7. The pump apparatus as claimed in claim 2, wherein a vacuum space is provided between the first and second metal housing main bodies.

8. The pump apparatus as claimed in claim 1, wherein the housing is formed on the external surface of the pump by molding.

9. The pump apparatus as claimed in claim 1, wherein the metal housing main body has an opening in one end of the metal housing main body and the housing further comprises a cover covering the opening, and the inlet hole and the outlet hole are positioned in the cover.

10. The pump apparatus as claimed in claim 9, wherein the cover is formed of one of synthetic polymer material and metal.

11. The pump apparatus as claimed in claim 1, wherein the metal housing main body has a through-opening, the housing further comprises a first cover to cover one end of the through-opening of the metal housing main body and a second cover to cover the other end of the through-opening of the metal housing main body, and the first cover has the inlet hole and the second cover has the outlet hole.

12. The pump apparatus as claimed in claim 1, further comprising a noise absorbing member inserted into the housing to surround the pump.

13. The pump apparatus as claimed in claim 1, wherein the pump comprises:
a pumping unit including an inlet pipe and an outlet pipe passing through the outlet hole; and
a motor providing pumping power to the pumping unit.

14. The pump as claimed in claim 13, wherein the pump further includes a rotating shaft and a propeller combined with the rotating shaft to provide a rotary power to the pumping unit, and the pumping unit is a chamber surrounding the propeller inserted into the pumping unit.

15. The pump as claimed in claim 1, wherein the pump is a fuel pump for supplying a fuel including hydrogen.

16. The pump as claimed in claim 1, wherein the pump is an air pump for supplying an oxidant.

17. A fuel cell system, comprising:
at least one electricity generator comprising an anode, a cathode, and an electrolyte membrane interposed between the anode and the cathode;
a first supplying unit supplying an oxidant to the cathode; and
a second supplying unit supplying a fuel to the anode, at least one of the first supplying unit and the second supplying unit comprising the pump apparatus of claim 1.

18. A pump apparatus for a fuel cell, comprising:
a pump having an inlet pipe for receiving a fluid and an outlet pipe for discharging the fluid; and
a housing formed on the external surface of the pump by molding, the housing having an inlet hole and an outlet hole for receiving and discharging the fluid, respectively, whereby the fluid is inputted into the pump through the inlet hole and the inlet pipe and the inputted gas or liquid is outputted through the output pipe and the output hole.

19. The pump as claimed in claim 18, wherein the housing is formed of at least one selected from the group consisting of metal, rubber, and polyurethane silicon.

20. A fuel cell system, comprising:
at least one electricity generator comprising an anode, a cathode, and an electrolyte membrane interposed between the anode and the cathode;
a first supplying unit supplying an oxidant to the cathode; and
a second supplying unit supplying a fuel to the anode, at least one of the first and second supplying units comprising a pump apparatus comprised of:
a housing comprising a metal housing main body having an inlet hole and an outlet hole; and
a pump inserted into the housing, the pump including an inlet pipe and an outlet pipe passing through the outlet hole, whereby the fuel or the oxidant is inputted into the pump through the inlet hole and the inlet pipe and the inputted gas or liquid is outputted through the output pipe.

21. The fuel cell system as claimed in claim 20, further comprising a controller for controlling an operation of the pump.

22. The fuel cell system as claimed in claim 20, wherein the fuel cell system is selected from the group consisting of a polymer electrolyte membrane fuel cell and a direct methanol fuel cell.
